(19) United States
(12) Patent Application Publication
(10) Pub. No.: US 2014/0319050 A1
(43) Pub. Date: Oct. 30, 2014

(54) WATER FILTER ASSEMBLY

(71) Applicant: GENERAL ELECTRIC COMPANY, Schenectady, NY (US)

(72) Inventor: Timothy Scott Shaffer, La Grange, KY (US)

(73) Assignee: General Electric Company, Schenectady, CA (US)

(21) Appl. No.: 13/872,500

(22) Filed: Apr. 29, 2013

(51) Int. Cl. C02F 1/00

(52) U.S. Cl. CPC C02F 1/003
USPC 210/493.5

(57) ABSTRACT

A water filter assembly is provided. The water assembly includes a cylindrical filter media, a pair of caps mounted at opposite ends of the cylindrical filter media, and a support column positioned within the cylindrical filter media. Inner and outer diameters of the cylindrical filter media can be selected in order to improve filtering of the cylindrical filter media. Also, at least one cap of the pair of caps can define an outlet having a diameter less than the inner diameter of the cylindrical filter media.

### FIELD OF THE INVENTION

The present subject relates generally to water filter assemblies.

### BACKGROUND OF THE INVENTION

Water filters are generally divided into two classes: point-of-entry water filters and point-of-use water filters. Point-of-entry water filters can be installed at a water line that supplies water to a business or residence in order to filter water entering the business or residence. Conversely, point-of-use water filters can be installed at a kitchen sink or within a refrigerator appliance in order to filter water entering such devices. In order to filter water, water filters are generally provided with a filtering media, such as a block of activated carbon or a pleated material.

In water filters with pleated filtering media, the water filter's filtering media generally removes contaminants such as sediment and other particles as water passes through pores in the filtering media. In such a manner, the water filter can remove such contaminants from water prior to delivering such water to a user. For example, the water filter can filter water prior to such water entering the refrigerator's ice maker or water dispenser.

The capacity and capability of point-of-entry water filters with pleated filtering media is directly related to the amount of filtering media surface area exposed to water flow between filtered and unfiltered regions of the water filters. Certain point-of-entry water filters with pleated filtering media have a fixed inner diameter and maximize available filtering media surface area by increasing the number of pleats at the inner diameter of the filtering media until no more pleats can be physically inserted. However, maximizing the number of pleats can be counterproductive under certain circumstances.

In point-of-entry water filters with pleated filtering media, the pleated filtering media is generally cylindrical in shape and comes in standard sizes. In particular, point-of-entry water filters with pleated filtering media generally have a six inch wide canister that accepts a pleated filtering media cartridge having a one inch inner diameter and a four and one half inches outer diameter or have a 4.5 inch wide canister that accepts a pleated filtering media cartridge having the same one inch inner diameter and a 2½ inch outer diameter. Such point-of-entry water filters with pleated filtering media generally have limited filtering capacity or capability. However, such point-of-entry water filters are widely used and replacing existing water filter assemblies in order to improve filtering capacity or capability can be prohibitively expensive or otherwise impractical.

Accordingly, a point-of-entry water filter with a pleated filtering media that is compatible with existing filter manifolds and also has improved or increased filtering capacity or capability would be useful. In particular, a point-of-entry water filter with a pleated filtering media that has increased surface area would be useful.

### BRIEF DESCRIPTION OF THE INVENTION

The present subject matter provides a water filter assembly. The water assembly includes a cylindrical filter media, a pair of caps mounted at opposite ends of the cylindrical filter media, and a support column positioned within the cylindrical filter media. Inner and outer diameters of the cylindrical filter media can be selected in order to improve filtering of the cylindrical filter media. At least one cap of the pair of caps can define an outlet having a diameter less than the inner diameter of the cylindrical filter media. Additional aspects and advantages of the invention will be set forth in part in the following description, or may be apparent from the description, or may be learned through practice of the invention.

In a first exemplary embodiment, a water filter assembly is provided. The water filter assembly defines an axial direction, a radial direction, and a circumferential direction. The water filter assembly includes a cylindrical filter media having a plurality of pleats spaced apart from one another along the circumferential direction. The cylindrical filter media also defines an inner diameter and an outer diameter along the radial direction. The inner diameter of the cylindrical filter media is greater than one and one-quarter inches and less than about three and three-quarters inches. The outer diameter of the cylindrical filter media is greater than the inner diameter of the cylindrical filter media. The cylindrical filter media also defines a filtering volume within the cylindrical filter media. A pair of caps is mounted to the cylindrical filter media. The caps are positioned at opposite axial ends of the cylindrical filter media. A support column is positioned within the filtering volume of the cylindrical filter media.

In a second exemplary embodiment, a water filter assembly is provided. The water filter assembly defines an axial direction, a radial direction, and a circumferential direction. The water filter assembly includes a cylindrical filter media having a plurality of pleats spaced apart from one another along the circumferential direction. The cylindrical filter media defines an inner diameter and an outer diameter along the radial direction. The cylindrical filter media also defines a filtering volume within the cylindrical filter media. A pair of caps is mounted to the cylindrical filter media. The caps are positioned at opposite axial ends of the cylindrical filter media. At least one cap of the pair of caps defines an outlet therethrough. The outlet of the at least one cap has a diameter along the radial direction. The diameter of the outlet is less than the inner diameter of the cylindrical filter media. A support column is positioned within the filtering volume of the cylindrical filter media.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water filtering apparatus according to an exemplary embodiment of the present subject matter.

FIG. 2 provides a section view of the exemplary water filtering apparatus of FIG. 1.

FIG. 3 provides a perspective view of a water filter assembly according to an exemplary embodiment of the present subject matter.

FIG. 4 provides an exploded view of the exemplary water filter assembly of FIG. 3.

FIG. 5 provides a top, section view of the exemplary water filter assembly of FIG. 3 taken along the 5-5 line of FIG. 3.

FIG. 6 provides a side, section view of the exemplary water filter assembly of FIG. 3 taken along the 6-6 line of FIG. 3.

FIG. 7 provides a partial, section view of a filter media of the exemplary water filter assembly of FIG. 3.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

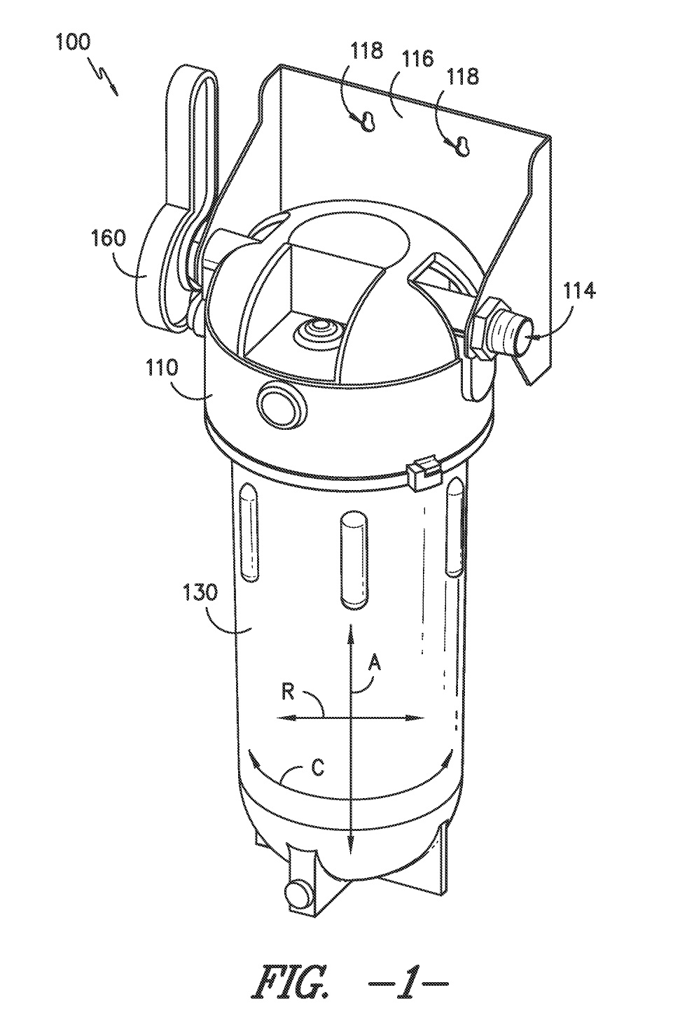

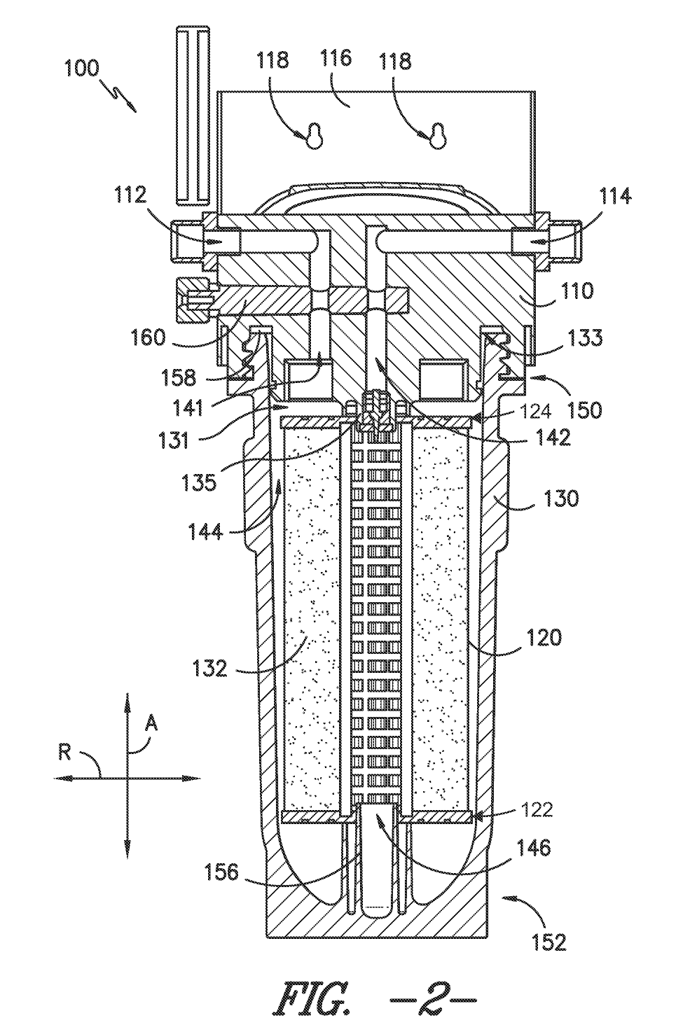

FIG. 1 provides a perspective view of a water filtering apparatus 100 according to an exemplary embodiment of the present subject matter. FIG. 2 provides a section view of water filtering apparatus 100. Water filtering apparatus 100 can filter water from a water supply (not shown), such as a municipal water source or a well. Water filtering apparatus 100 can remove contaminants and other undesirable substances from water passing therethrough. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water filtering apparatus 100 may be used as a point-of-use water filter. For example, water filtering apparatus 100 may be used at or within any suitable appliance, such as a refrigerator appliance or an ice maker. Similarly, water filtering apparatus 100 may be installed beneath a sink. In alternative exemplary embodiments, water filtering apparatus 100 may be used as a point-of-entry water filtration system for an entire household or business.

Water filtering apparatus 100 defines an axial direction A, a radial direction R, and a circumferential direction C. Water filtering apparatus 100 also includes a manifold 110 and a casing 130 removably mounted to manifold 110. Manifold 110 includes a mounting bracket 116 that defines holes 118. Fasteners (not shown) such as nails, pegs, tabs, screws, or bolts may be inserted through holes 118 to mount water filtering apparatus 100, e.g., within an appliance, to a kitchen cabinet beneath a kitchen sink, or to a wall within a house. Manifold 110 also defines an entrance 112 and an exit 114. Entrance 112 may be in fluid communication with a water supply and receive unfiltered water from the water supply. From entrance 112, such unfiltered water is directed through water filtering apparatus 100. Such unfiltered water passes through water filtering apparatus 100 and exits manifold 110 at exit 114 as filtered water. Manifold 110 includes a shut off valve 160 for regulating, e.g., selectively terminating or obstructing, the flow of water through water filtering apparatus 100.

Casing 130 define a chamber 131 for receipt of water for filtering. Casing 130 extends between a top portion 150 and a bottom portion 152, e.g., along the axial direction A. Casing 130 defines an opening 133 at top portion 150 of casing 130. Opening 133 permits access to chamber 131 of casing 130. Casing 130 is removably mounted to manifold 110. For example, threads on casing 130 at top portion 150 of casing can engage threads on manifold 110 to mount casing 130 to manifold 110. A seal 158 extends between manifold 110 and casing 130, e.g., at opening 133 of casing 130, to assist within hindering fluid flow out of opening 133 of casing 130 when casing 130 is mounted to manifold 110.

Manifold 110 further defines an inlet 141 and an outlet 142. Inlet 141 is in fluid communication with entrance 112 of manifold 110 and with chamber 131 of casing 130. Thus, unfiltered water can enter chamber 131 of casing 130 through inlet 141 of manifold 110. Outlet 142 of manifold 110 is in fluid communication with exit 114 of manifold 110 and chamber 131 of casing 130. Thus, filtered water can exit chamber 131 of casing 130 through outlet 142 of manifold 110.

A water filter cartridge or assembly 120 is disposed within chamber 131 and is accessible and/or replaceable via opening 133 of casing 130. Water filter assembly 120 includes a filtering media 132. Filtering media 132 divides chamber 131 into an unfiltered volume 144 and a filtered volume 146. Filtering media 132 can remove impurities and contaminants from water passing through filtering media 132 from unfiltered volume 144 to filtered volume 146.

As used herein, the term “unfiltered” describes a volume within chamber 131 that is not filtered relative to filtering media 132. However, as will be understood by those skilled in the art, water filtering apparatus 100 may include additional filters that filter water entering chamber 131. Thus, “unfiltered volume” may be filtered relative to other filters but not filtering media 132.

As an example, water passing though water filtering apparatus 100 can follow a path through water filtering apparatus 100. In particular, unfiltered water can enter water filtering apparatus 100 through entrance 112 of manifold 110. Such unfiltered water can then flow though inlet 141 of manifold 110 into unfiltered volume 144 of chamber 131. Such unfiltered water can pass though filtering media 132 to remove impurities and can exit filtering media 132 into filtered volume 146 of chamber 131 as filtered water. Such filtered water can then pass through outlet 142 of manifold 110 and exit water filtering apparatus 100 through exit 114 of manifold 110. In such a manner, unfiltered water can follow the path through water filtering apparatus 100. In particular, unfiltered water can pass though filtering media 132, and filtered water can exit water filtering apparatus 100. Such filtering can improve taste and/or safety of water.

To support water filter assembly 120 within casing 130, casing 130 includes a brace 156 mounted at or proximate bottom portion 152 of casing 130 within chamber 131 of casing 130. Brace 156 of casing 130 engages water filter assembly 120 at a bottom portion 122 of water filter assembly 120 in order to support water filter assembly 120 within chamber 131 of casing 130. Similarly, a brace 135 of manifold 110 engages water filter assembly 120 at a top portion 124 of water filter assembly 120 in order to support water filter assembly 120 within chamber 131 of casing 130. In particular, top portion 124 of water filter assembly 120 engages brace 135 of manifold 110 at or proximate outlet 142 of manifold 110 in order to support water filter assembly 120 within chamber 131 of casing 130. Thus, water filter assembly 120 may be supported at bottom and top portions 122 and 124 of water filter assembly 120 within casing 130.

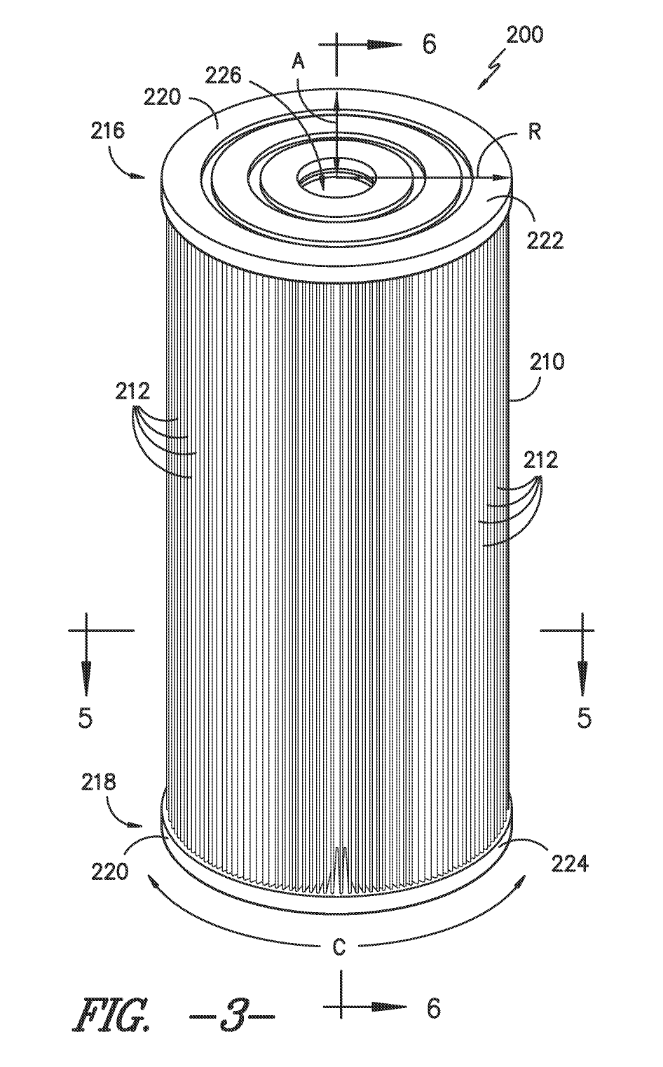

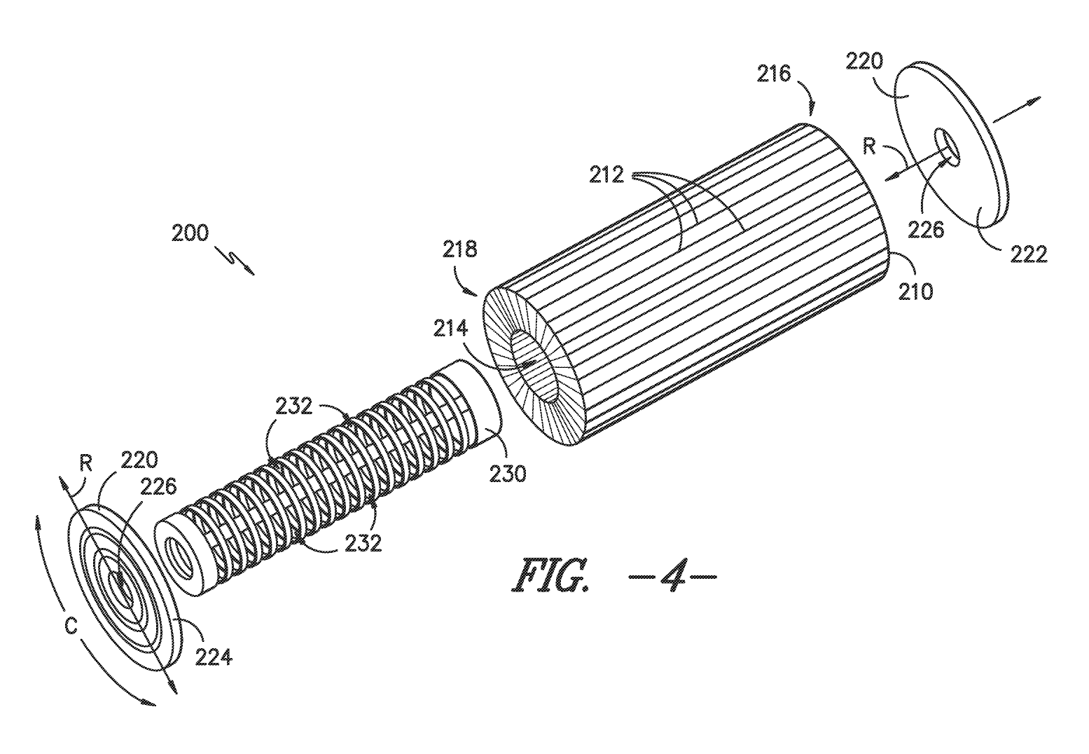

FIG. 3 provides a perspective view of a water filter assembly 200 according to an exemplary embodiment of the present subject matter. FIG. 4 provides an exploded view of water filter assembly 200. Water filter assembly 200 may be used in any suitable water filtering apparatus, such as water filtering apparatus 100 (FIG. 1). Thus, water filter assembly 200 may be used as water filter assembly 200 may be used as water filter assembly 120 (FIG. 2) in water filtering apparatus 100.

Water filter assembly 200 includes a substantially cylindrical filter media 210. Cylindrical filter media 210 has a plurality of pleats 212. Pleats 212 are spaced apart from each other, e.g., along the circumferential direction C. Pleats 212 can include any suitable number of pleats. For example, pleats 212 may include at least one hundred pleats. In particular, pleats 212 may include about one hundred and fifty pleats. Cylindrical filter media 210 also defines a filtering volume 214, e.g., within cylindrical filter media 210.

Cylindrical filter media 210 can include any suitable material for removing contaminants and/or sediment from water. For example, cylindrical filter media 210 may be constructed from sheets of cellulose, polypropylene, polystyrene, etc. folded into cylindrical filter media 210 with pleats 212. In certain exemplary embodiments, cylindrical filter media 210 defines a plurality of pores (not shown) therethrough. The pores can permit water to pass through cylindrical filter media 210 while cylindrical filter media 210 obstructs or blocks contaminants and/or sediment from passing through cylindrical filter media 210. As an example, the pores may have a size between about one-half micron and two hundred microns. Thus, the pores can permit water to flow through cylindrical filter media 210 into filtering volume 214 of cylindrical filter media 210.

Water filter assembly 200 also includes a pair of caps 220. In particular, caps 220 include a first cap 222 and a second cap 224. Caps 220 are mounted to cylindrical filter media 210. In particular, caps 220 are positioned at opposite axial ends of cylindrical filter media 210. Thus, first cap 222 is mounted to cylindrical filter media 210 at a first end portion 216 of cylindrical filter media 210. Conversely, second cap 224 is mounted to cylindrical filter media 210 at a second end portion 218 of cylindrical filter media 210. First and second end portions 216 and 218 of cylindrical filter media 210 are spaced apart from each other, e.g., along the axial direction A. Caps 220 can be mounted to cylindrical filter media 210 using any suitable mechanism. For example, caps 220 may be mounted to cylindrical filter media 210 using glue, compression fit, over-molding, ultrasonic welding, etc.

Caps 220, e.g., first cap 222 and second cap 224, define outlets 226 therethrough. Outlets 226 can direct water out of filtering volume 214 of cylindrical filter media 210. For example, water filtered by cylindrical filter media 210 can exit filtering volume 214 of cylindrical filter media 210 via one of outlets 226. Outlets 226 can also assist with supporting cylindrical filter media 210, e.g., within casing 130 of water filtering apparatus 100 (FIG. 2). As an example, brace 135 of manifold 110 can be positioned within or proximate one of outlets 226. Similarly, brace 156 of casing 130 can be positioned within or proximate another of outlets 226. Thus, cylindrical filter media 210 can be supported at first and second end portions 216 and 218 of cylindrical filter media 210 by brace 135 of manifold 110 and brace 156 of casing 130.

Water filter assembly 200 further includes a support column 230. In certain exemplary embodiments, support column 230 has a generally cylindrical shape as shown in FIG. 4. Support column 230 is positioned within filtering volume 214 of cylindrical filter media 210. Support column 230 can engage cylindrical filter media 210 within filtering volume 214 of cylindrical filter media 210 in order to support or brace cylindrical filter media 210. As discussed above, cylindrical filter media 210 can be constructed with a relatively flexible or flimsy material, such a polymer film. Support column 230 can engage cylindrical filter media 210 to assist with preventing cylindrical filter media 210 from buckling and/or warping.

Support column 230 defines a plurality of openings 232, e.g., spaced apart from one another along at least one of the axial direction A and the circumferential direction C. Openings 232 can permit liquids, such as water, to flow through cylindrical filter media 210 and support column 230. In particular, openings 232 can permit such liquids to flow through cylindrical filter media 210 and support column 230 into filtering volume 214 of cylindrical filter media 210.

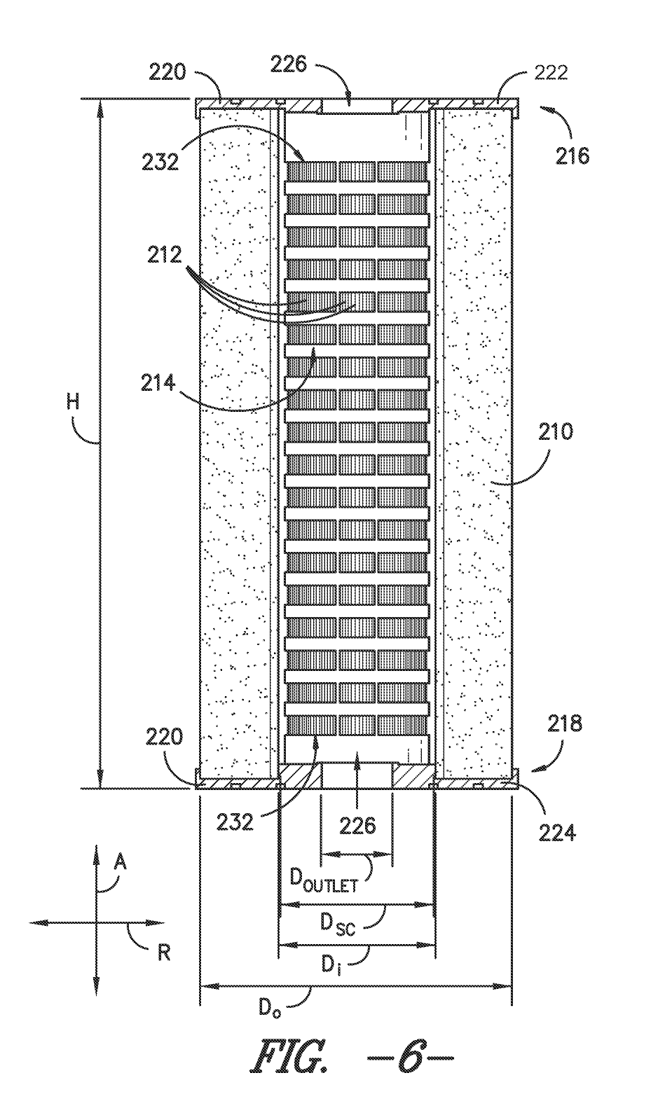

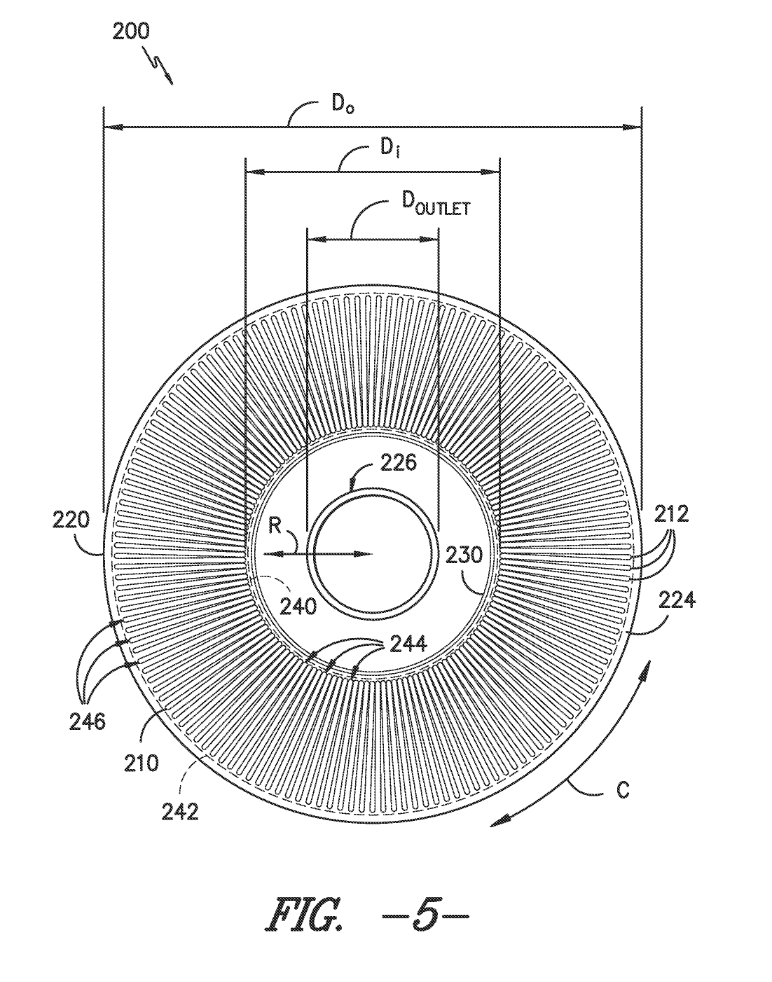

FIG. 5 provides a top, section view of water filter assembly 200 taken along the 5-5 line of FIG. 3. FIG. 6 provides a side, section view of water filter assembly 200 taken along the 6-6 line of FIG. 3. As may be seen in FIGS. 5 and 6, cylindrical filter media 210 defines an inner diameter Dᵢ and an outer diameter Dₒ, e.g., along the radial direction R. As best seen in FIG. 5, pleats 212 include inner bends 244 and outer bends 246, e.g., spaced apart from each other along the radial direction R. Inner bends 244 of pleats 212 define an inner perimeter 240 of cylindrical filter media 210. Inner perimeter 240 of cylindrical filter media 210 extends between and connects inner bends 244 of pleats 212. Similarly, outer bends 246 of pleats 212 define an outer perimeter 242 of cylindrical filter media 210. Outer perimeter 242 of cylindrical filter media 210 extends between and connects outer bends 246 of pleats 212 Inner diameter Dᵢ extends between opposite sides of inner perimeter 240 of cylindrical filter media 210, e.g., along the radial direction R. Similarly, outer diameter Dₒ extends between opposite sides of outer perimeter 242 of cylindrical filter media 210, e.g., along the radial direction R.

Outer diameter Dₒ can be any suitable diameter. Similarly, inner diameter Dᵢ can be any suitable diameter. As an example, inner diameter Dᵢ of cylindrical filter media 210 may be greater than about one and one-quarter inches and less than about three and three-quarters inches, and outer diameter Dₒ of cylindrical filter media 210 may be about four and one-half inches or about two and one-half inches. As another example, inner diameter Dᵢ of cylindrical filter media 210 may be greater than or equal to about one and three-quarters inches and less than or equal to about two and three-quarters inches. As yet another example, inner diameter Dᵢ of cylindrical filter media 210 may be about two and one-eighth inches.

By providing cylindrical filter media 210 with inner diameter Dᵢ of cylindrical filter media 210 greater than about one and one-quarter inches, a filtering capacity and/or capability of water filter assembly 100 can be improved or increased. For example, for cylindrical filter media 210 with outer diameter Dₒ of cylindrical filter media 210 being about four and one-half inches, a total surface area of cylindrical filter media 210 can increase by increasing inner diameter Dᵢ of cylindrical filter media 210 from about one inch to about three and one-quarter inches. Similarly, for cylindrical filter media 210 with outer diameter Dₒ of cylindrical filter media 210 being about two and one-half inches, the total surface area of cylindrical filter media 210 can increase by increasing inner diameter Dᵢ of cylindrical filter media 210 from about one inch to about one and one-half inches.

Support column 230 also defines an outer diameter D_{sc}, e.g., along the radial direction R. Outer diameter D_{sc} of support column 230 can be any suitable diameter. For example, outer diameter D_{sc} of support column 230 may be about equal to inner diameter Dᵢ of cylindrical filter media 210. Thus, support column 230 may be positioned adjacent or in contact with inner bends 244 of pleats 212. In such a manner, support column 230 can assist with supporting or bracing cylindrical filter media 210 as discussed above.

Outlets 226 of caps 220 also define a diameter Dₒᵤₜₗₑₜ, e.g., along the radial direction R. Diameter Dₒᵤₜₗₑₜ of outlet 226 can be any suitable diameter. For example, diameter Dₒᵤₜₗₑₜ of outlets 226 may be less than inner diameter Dᵢ of cylindrical filter media 210. In particular, diameter Dₒᵤₜₗₑₜ of outlet 226 may be about one inch. Thus, outlets 226 of caps 220 can receive braces, such as brace 135 of manifold 110 (FIG. 2) and/or brace 156 of casing 130 (FIG. 2), that are smaller than inner diameter Dᵢ of cylindrical filter media 210. Thus, braces that are relatively small compared to inner diameter Dᵢ of cylindrical filter media 210 can be used to support water filter assembly 200. In addition, proper sizing of diameter Dₒᵤₜₗₑₜ of outlet 226 can permit cylindrical filter media 210 to engage and be compatible with existing filter manifold interfaces.

Cylindrical filter media 210 also has a height H, e.g., along the axial direction A. Height H can be any suitable height. For example, height H of cylindrical filter media 210 may be about nine and seven-eighths inches.

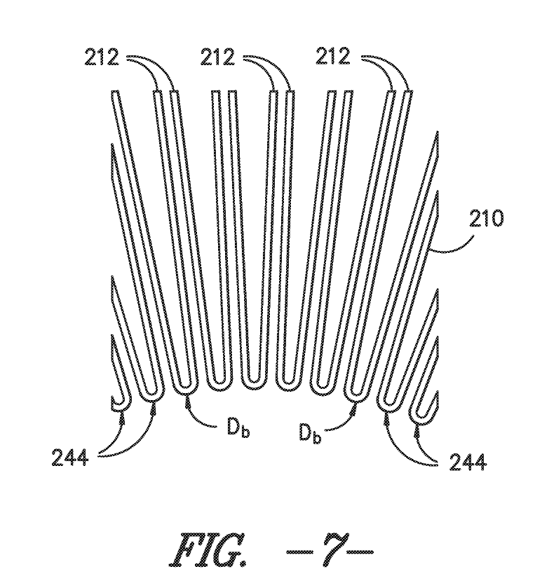

FIG. 7 provides a partial, section view of cylindrical filter media 210 of water filter assembly 200. As may be seen in FIG. 7, pleats 212 have a bend diameter D_{b}. Bend diameter D_{b} can be any suitable diameter. For example, bend diameter D_{b} may be about forty-five thousands of an inch Inner and outer bends 244 and 246 of pleats 212 can have equal bend diameter D_{b}.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water filter assembly that defines an axial direction, a radial direction, and a circumferential direction, the water filter assembly comprising:
a cylindrical filter media having a plurality of pleats spaced apart from one another along the circumferential direction, the cylindrical filter media defining an inner diameter and an outer diameter along the radial direction, the inner diameter of the cylindrical filter media being greater than one and one-quarter inches and less than about three and three-quarters inches, the outer diameter of the cylindrical filter media being greater than the inner diameter of the cylindrical filter media, the cylindrical filter media also defining a filtering volume within the cylindrical filter media;
a pair of caps mounted to the cylindrical filter media, the caps positioned at opposite axial ends of the cylindrical filter media; and
a support column positioned within the filtering volume of the cylindrical filter media.

2. The water filter assembly of claim 1, wherein the support column comprises a cylindrical support column, the cylindrical support column defining an outer diameter along the radial direction, the outer diameter of the cylindrical support column being about equal to the inner diameter of the cylindrical filter media.

3. The water filter assembly of claim 1, wherein the support column defines a plurality of openings for permitting liquids to flow through the cylindrical filter media and the support column into the filtering volume of the cylindrical filter media.

4. The water filter assembly of claim 1, wherein at least one cap of the pair of caps defines an outlet therethrough.

5. The water filter assembly of claim 4, wherein the outlet of the at least one cap has a diameter along the radial direction, the diameter of the outlet being about one inch.

6. The water filter assembly of claim 1, wherein the cylindrical filter media has a height along the axial direction, the height of the cylindrical filter media being about nine and seven-eighths inches.

7. The water filter assembly of claim 1, wherein each pleat of the plurality of pleats has a bend diameter, the bend diameter being about forty-five thousands of an inch.

8. The water filter assembly of claim 1, wherein the plurality of pleats comprises at least one hundred pleats.

9. The water filter assembly of claim 1, wherein the cylindrical filter media comprises cellulose, polypropylene, or polystyrene.

10. The water filter assembly of claim 1, wherein the cylindrical filter media defines a plurality of pores therethrough, each pore of the plurality of pores having a size between about one-half micron and two hundred microns.

11. A water filter assembly that defines an axial direction, a radial direction, and a circumferential direction, the water filter assembly comprising:
a cylindrical filter media having a plurality of pleats spaced apart from one another along the circumferential direction, the cylindrical filter media defining an inner diameter and an outer diameter along the radial direction, the cylindrical filter media also defining a filtering volume within the cylindrical filter media;
a pair of caps mounted to the cylindrical filter media, the caps positioned at opposite axial ends of the cylindrical filter media, at least one cap of the pair of caps defining an outlet therethrough, the outlet of the at least one cap has a diameter along the radial direction, the diameter of the outlet being less than the inner diameter of the cylindrical filter media; and
a support column positioned within the filtering volume of the cylindrical filter media.

12. The water filter assembly of claim 10, wherein the support column comprises a cylindrical support column, the cylindrical support column defining an outer diameter along the radial direction, the outer diameter of the cylindrical support column being about equal to the inner diameter of the cylindrical filter media.

13. The water filter assembly of claim 10, wherein the support column defines a plurality of openings for permitting liquids to flow through the cylindrical filter media and the support column into the filtering volume of the cylindrical filter media.

14. The water filter assembly of claim 10, wherein the diameter of the outlet is about one inch.

15. The water filter assembly of claim 10, wherein the inner diameter of the cylindrical filter media is about two and one-eighth inches and the outer diameter of the cylindrical filter media is about four and one-half inches.

16. The water filter assembly of claim 15, the diameter of the outlet is about one inch.

17. The water filter assembly of claim 10, wherein the cylindrical filter media has a height along the axial direction, the height of the cylindrical filter media being about nine and seven-eighths inches.

18. The water filter assembly of claim 10, wherein each pleat of the plurality of pleats has a bend diameter, the bend diameter being about forty-five thousands of an inch.

19. The water filter assembly of claim 10, wherein the plurality of pleats comprises at least one hundred pleats.

20. The water filter assembly of claim 10, wherein the cylindrical filter media comprises cellulose, polypropylene, or polystyrene.
